(19) United States
(12) Patent Application Publication
(10) Pub. No.: US 2002/0108034 A1
(43) Pub. Date: Aug. 8, 2002

(54) System and method for automatically securing data for transmission

(76) Inventors: Tony Hashem, Lynchburg, VA (US); Christine Fleming, Centreville, VA (US)

Correspondence Address: Jennifer A. Albert, Esq., Hunton & Williams, Suite 1200, 1900 K Street, N.W., Washington, DC, 20006, US

(21) Appl. No.: 09/773,535

(22) Filed: Feb. 2, 2001

(51) Int. Cl. H04L 9/00

(52) U.S. Cl. 713/153

(57) ABSTRACT

A system and method for automatically encrypting and decrypting data for transmission. The process includes retrieving a file from a destination based transmit folder, encrypting the file, and transmitting the file to an outgoing folder for transmission to the destination. The file is encrypted with an encryption process associated with the destination based transmit folder. The process also includes retrieving a file from a destination based received folder, decrypting the file, and transmitting the file to an outgoing folder for access at the destination. The file is decrypted with a decryption process associated with the destination based received folder.

### BACKGROUND OF THE INVENTION

The present invention relates generally to data transmission in a communications system and, more particularly, to easily automate encryption and decryption of data for transmission in a communications system.

As data processing systems become paperless, there is growing demand for fast and secure electronic document submission methods. One approach is to use leased communications lines, between a sender and a receiver with no outside access, to transmit these documents. This method is expensive to maintain and requires a substantial initial investment in money and time for providers and users of data processing systems.

Another approach is to encrypt documents before sending over the Internet. However, this approach is also expensive and inefficient because it requires manual effort to encrypt documents for transmitting and to decrypt received documents.

### BRIEF SUMMARY OF THE INVENTION

A system and method for easily or automatically encrypting and decrypting data for transmission is described. In one exemplary embodiment, the process includes retrieving a file from a destination based transmit folder, encrypting the file, and transmitting the file to an outgoing folder for transmission to the destination. The file is encrypted with an encryption process associated with the destination based transmit folder. The process also includes retrieving a file from a destination based received folder, decrypting the file, and transmitting the file to an outgoing folder for access at the destination. The file is decrypted with a decryption process associated with the destination based received folder.

### BRIEF DESCRIPTION OF THE DRAWINGS

FIG. 1 is a block diagram illustrating one embodiment of a system using the present invention;

FIG. 2 is a block diagram illustrating a user system according to one embodiment of the present invention;

FIG. 3 is a block diagram illustrating one embodiment of a method of transmitting data; and

FIG. 4 is a flow diagram illustrating one embodiment of a method of receiving data.

### DETAILED DESCRIPTION OF THE INVENTION

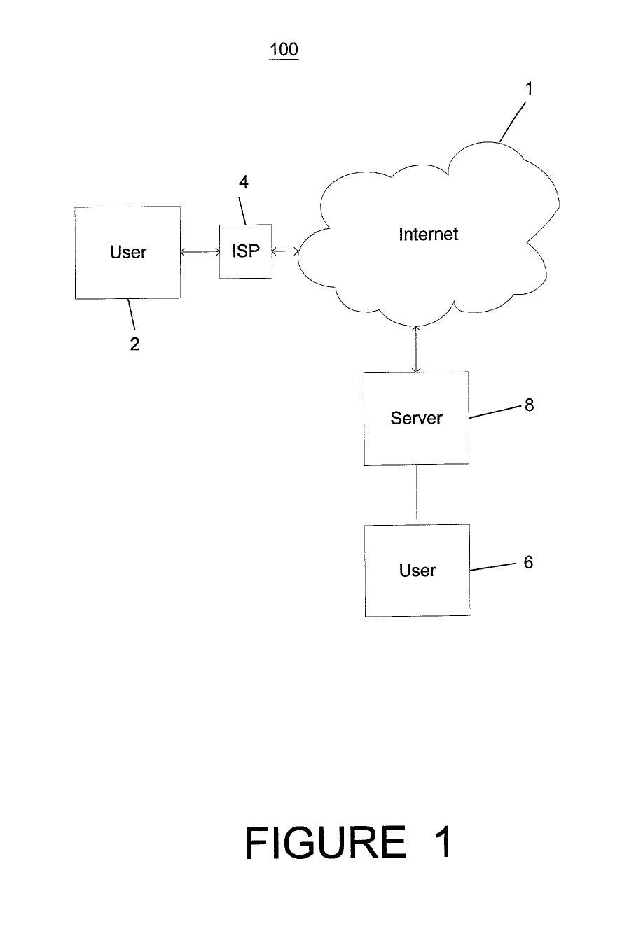

FIG. 1 is a block diagram of one embodiment of a system using the present invention. System 100 may include users 2, 6, internet service provider (“ISP”) 4, server 8 and communications link 1.

Users 2, 6 may exchange information with each other through a communications link or network, such as, for example, the Internet 1. The communications link may be, include or interface to any one or more of, for instance, the Internet, an intranet, a PAN (Personal Area Network), a LAN (Local Area Network), a WAN (Wide Area Network) or a MAN (Metropolitan Area Network), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. The communications link may furthermore be, include or interface to any one or more of a WAP (Wireless Application Protocol) link, a GPRS (General Packet Radio Service) link, a GSM (Global System for Mobile Communication) link, a CDMA (Code Division Multiple Access) or TDMA (Time Division Multiple Access) link such as a cellular phone channel, a GPS (Global Positioning System) link, CDPD (cellular digital packet data), a RIM (Research in Motion, Limited) duplex paging type device, a Bluetooth radio link, or an IEEE 802.11-based radio frequency link. The communications link may yet further be, include or interface to any one or more of an RS-232 serial connection, an IEEE-1394 (Firewire) connection, a Fibre Channel connection, an IrDA (infrared) port, a SCSI (Small Computer Systems Interface) connection, a USB (Universal Serial Bus) connection or other wired or wireless, digital or analog interface or connection.

Users or clients 2, 6 may be connected to the internet 1 through ISP 4 or server 8 or any other internet access method. Clients 2, 6 may be or include, for instance, a personal computer running the Microsoft Windows™ 95, 98, Millenium™, NT™, or 2000, Windows™CE™, PalmOS™, Unix, Linux, Solaris ™, OS/2™, BeOS™, MacOS™ or other operating system or platform. Client 102 may include a microprocessor such as an Intel x86-based device, a Motorola 68K or PowerPC™ device, a MIPS, Hewlett-Packard Precision™, or Digital Equipment Corp. Alpha™ RISC processor, a microcontroller or other general or special purpose device operating under programmed control. Client 2, 6 may furthermore include electronic memory such as RAM (random access memory) or EPROM (electronically programmable read only memory), storage such as a hard drive, CDROM or rewritable CDROM or other magnetic, optical or other media, and other associated components connected over an electronic bus, as will be appreciated by persons skilled in the art. Client 2, 6 may also be or include a network-enabled appliance such as a WebTV™ unit, radio-enabled Palm™ Pilot or similar unit, a set-top box, a networkable game-playing console such as Sony Playstation™ or Sega Dreamcast™, a browser-equipped cellular telephone, or other TCP/IP client or other device.

Clients 2, 6 may communicate through the network 1 using network enabled code or other appropriate language. Network enabled code may be, include or interface to, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

The server 8 may be or include, for instance, a workstation running the Microsoft Windows™NT™, Windows™ 2000, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform.

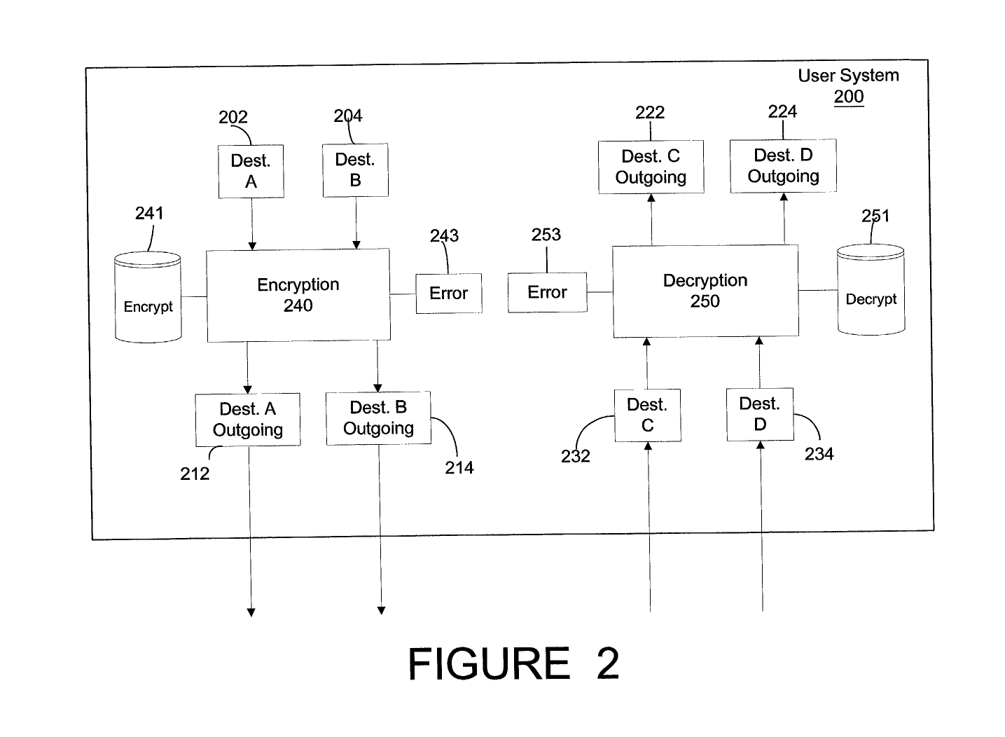

FIG. 2 is a block diagram illustrating one embodiment of a system for transmitting and receiving data according to the present invention. User system 200 may include encryption module 240 and decryption module 250. The system may also include destination based folders 202, 204, 232, 234, destination based outgoing folders 212, 214, 222, 224, databases 241, 251, and error modules 243, 253.

The databases 241, 251 may be, include or interface to, for example, the Oracle™ relational database sold commercially by Oracle Corp. Other databases, such as Informix™, DB2 (Database 2), Sybase or other data storage or query formats, platforms or resources such as OLAP (On Line Analytical Processing), SQL (Standard Query Language), a storage area network (SAN), Microsoft Access™ or others may also be used, incorporated or accessed in the invention.

Encryption module 240 may be coupled to destination based folders 202, 204 and destination based outgoing folders 212, 214. Encryption module 240 may also be coupled to an encryption database 241 and an error module 243. Destination based folders 202, 204 may receive data that is to be forwarded to a specific destination. Thus, an operator or user may place data to be transmitted to destination A in the destination A transmit folder 202. The user would place data to be transmitted to destination B in destination B transmit folder 204.

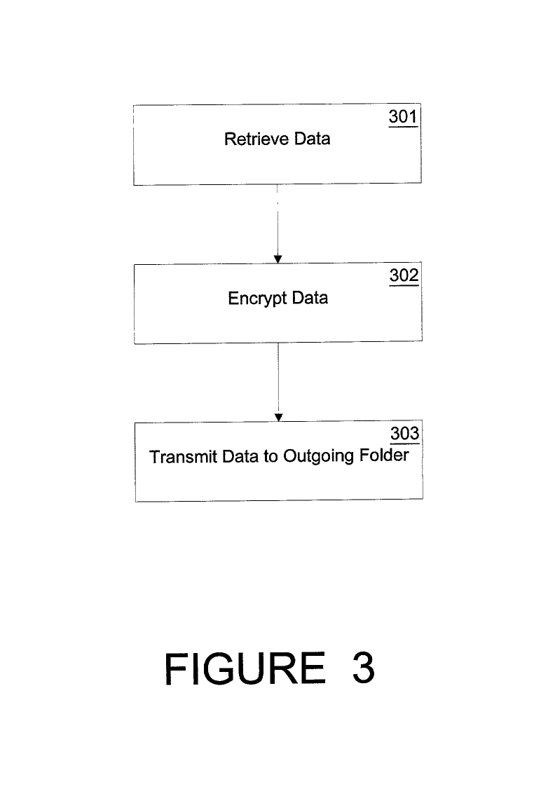

The data may be encrypted in encryption module 240, as described below with reference to FIG. 3. The encryption module 240 may retrieve an encryption key or other encryption processes from encryption database 241. Errors in encryption may be stored and/or processed in error module 243, as described below with reference to FIG. 3.

In one embodiment, the system 200 may include a file compression module for compressing the data to be encrypted. Compressing data or data files before encryption would reduce the size of the file being transmitted, reducing the resources required to transmit the file.

Once the data has been encrypted, the encryption module 240 may place the encrypted data in a destination-based outgoing folder 212, 214. For example, data to be transmitted to destination A may be placed in destination A outgoing folder 212 and data to be transmitted to destination B may be placed in destination B outgoing folder 214.

Decryption module 215 may receive data to be decrypted from destination-based folders 232, 234. For example, encrypted data entering user system 200 may be directed to folders based on the data's destination within user system 200. Thus, data directed to destination C within user system 200 may be placed in the destination C received folder 232. Encrypted data having a destination of destination D within user system 200 may be placed in the destination D received folder 234.

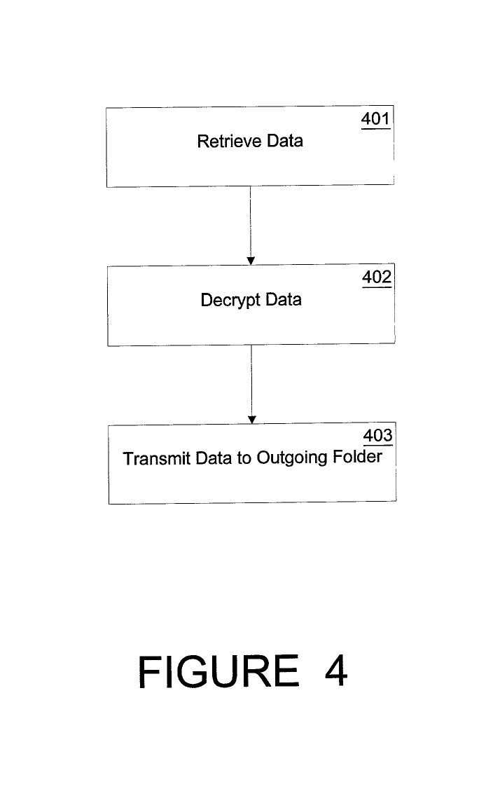

Decryption module 250 may retrieve the data to be decrypted from the destination-based folders 232, 234. Decryption module 250 may then decrypt the data, as described below with reference to FIG. 4.

Decryption module may retrieve a decryption key or other decryption processes from a decryption database 251. Errors during decryption may be stored and/or processed by error module 253.

Once the data has been decrypted, the data may be placed in an outgoing destination-based folder 222, 224. For example, data directed to destination C would be placed in the destination C outgoing folder 222 and data directed to destination D would be placed in destination D outgoing folder 224, after decryption. The data in the destination-based outgoing folders 222, 224 may be accessed at the respective destination. For example, the data in destination C outgoing folder 222 may be accessed at destination C.

In one embodiment, the system may include a decompression module to decompress any data that has been transmitted in an compressed form. In another embodiment, the data may be decompressed at the destination, such as at destination C.

Two destinations for encryption and two destinations for decryption were shown for illustrative purposes only. User system 200 may include as few as one folder for decryption and one folder for encryption or as many destination-based folders and destination-based outgoing folders as desired for encryption and decryption.

In one embodiment, any available encryption/decryption key or program may be used with the present invention to encrypt and decrypt data, as described below with reference to FIGS. 3 and 4. In another embodiment, an encryption/decryption key or program may be incorporated with the present invention to form an integrated application. For example, PGP™ Software, from Network Associates, may be integrated with the present invention using the PGP™ Software Development Tool Kit. Thus, a user would need to obtain and install only one program to transmit and receive data according to the present invention.

FIG. 3 is a flow diagram illustrating one method of transmitting data according to the present invention. At step 301, the system retrieves data from destination-based folders 202, 204. At step 302, the system encrypts the data with no manual intervention. At step 303, the system transmits the data to a destination-based outgoing folder 212, 214.

As described above, data may be placed in destination-based folders 202, 204, by a user, based on the destination to which the data is to be transmitted. At step 301, the system 200 may retrieve data from one of the destination-based folders 202, 204. The system may be configured to automatically check each destination-based folder 202, 204 for new files after predetermined time intervals. For example, the system may automatically check each destination-based transmit folder 202, 204 for new files every 30 seconds or some other user-defined time interval.

At step 302, the system 200 encrypts the data. In one embodiment, the system 200 may retrieve, from encryption database 241, an encryption process associated with the destination-based folder 202, 204 from which the data was retrieved. For example, if data was retrieved from the destination A transmit folder, the system would retrieve an encryption process associated with the destination A folder.

In one embodiment, the encryption process retrieved may be a public key, such as the public keys used to encode data to be transmitted in the PGP™ encryption system. For example, the data may be encrypted using PGP™ DOS command line options.

If data fails encryption, the data may be moved to an error directory in error module 243 and/or information regarding the data may be recorded in an error log in error module 243.

Once the files have been encrypted, they may be moved to a temporary folder where the system may verify that the data has been encrypted. Any data file failing the verification process may also be moved to the error directory and/or recorded in the error log. In one embodiment, the system 200 may also transmit notification of encryption or verification failure of a data file to a designated recipient of the file. In one embodiment, the system 200 may transmit error logs based on recipients to each recipient.

Once verified, the system 200 may move the data to an outgoing folder at step 303. The outgoing folder may comprise a destination-based outgoing folder such as destination A outgoing folder 212 and destination B outgoing folder 214. In one embodiment, the outgoing folder may be a general outgoing folder receiving encrypted data to be transmitted to any destination. The data in the outgoing folder 212, 214 may then be transmitted over an insecure channel. For example, the data may then be transmitted over the internet 1 or using FTP.

In one embodiment, the system may generate a file notifying the recipient designated by the file that the file is being transmitted. In another embodiment, the system may perform a scan for encryption key software, such as the PGP™ encryption system, either prior to starting the encryption/decryption process or at the time of the encryption/decryption system installation. In a further embodiment, the system may transmit a list of files from the destination-based transmit folders 202, 204 to the outgoing folders 212, 214 to reconcile files being transferred from the destination-based transmit folder to the outgoing folder.

In one embodiment, an FTP client may be included in the system 200. The FTP client may pick up files from the outgoing folder 212, 214, transmit the data, and verify the receipt of the data.

FIG. 4 is a flow diagram illustrating one embodiment of a method for receiving data according to the present invention. At step 401, the system may retrieve data from a destination-based received folder 232, 234. At step 402, the system decrypts the data. At step 403, the system transmits the data to an outgoing folder to be retrieved at the appropriate destination.

When a file is received by user system 200, the system may place the file in an appropriate destination-based received folder 232, 234. In one embodiment, the system may determine the destination of the received data and place the data in the appropriate folder 232, 234.

The system may then retrieve the data from the destination-based received folder at step 401. Retrieving the data from the destination-based received folders 222, 224 may include automatically checking the destination-based received folders 222, 224 at predetermined time intervals for new data.

At step 402, the system may decrypt the received data. In one embodiment, the system may retrieve a decryption key or other decryption processes from a decryption database 251. For example, the system may retrieve a decryption key such as a private key of the PGP™ encryption system.

The system may move the data to an error directory if the data fails the decryption process. In one embodiment, the system may record information regarding the data in an error log if the data fails the decryption process. The system may further transmit notification of decryption failure of the data to a designated recipient of the data at the destination if the data fails decryption.

In one embodiment, the system may transfer the decrypted data to a temporary file to determine whether the data has been decrypted. In another embodiment, if the data fails verification, the data may be moved to an error directory in error module 253, and/or information regarding the data may be recorded in an error log in the error module 253. In another embodiment, if the data fails decryption and/or verification, a notice may be transmitted to the designated recipient of the file at the destination that the file has failed either decryption and/or verification. In one embodiment, error logs based on recipients may be transmitted to the designated recipients of the data.

When the decryption is completed, the system may transfer the decrypted data to a destination-based outgoing folder 222, 224. The data may then be accessed by the specified destination. For example, if data is designated to be received by destination C, user system 200 may place the encrypted received data in destination C received folder 232. After the decryption process 250, the system may transmit the decrypted data to destination C outgoing folder 222. The decrypted data may then be accessed by users or a system at destination C.

The term “computer-readable medium” as used herein refers to any medium that participates in providing instructions to the processor for execution. Such a medium may take many forms, including but not limited to non-volatile media, volatile media, and transmission media. Non-volatile media include dynamic memory, such as main memory. Transmission media include coaxial cables, copper wire and fiber optics, including the wires that comprise the bus. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A method for transmitting data comprising:
retrieving a file from a destination based transmit folder;
encrypting the file with an encryption process associated with the destination based transmit folder; and
transmitting the file to an outgoing folder for transmission to the destination.

2. The method of claim 1 further comprising retrieving the encryption process associated with the destination based transmit folder from an encryption database.

3. The method of claim 1 further comprising verifying that the file has been encrypted.

4. The method of claim 3 wherein verifying that the file has been encrypted comprises transferring the file to a temporary folder and checking if all files in the temporary folder have been encrypted.

5. The method of claim 3 further comprising moving the file to an error directory if the file fails the verification process.

6. The method of claim 3 further comprising recording information about the file in an error log if the file fails the verification process.

7. The method of claim 6 further comprising transmitting a destination based portion of the error log to the destination.

8. The method of claim 3 wherein transmitting the file to the outgoing folder comprises transmitting the verified file to the outgoing folder.

9. The method of claim 3 further comprising transmitting notification of verification failure of the file to the destination if the file fails verification.

10. The method of claim 1 further comprising transmitting notification of encryption failure of the file to the destination if the file fails encryption.

11. The method of claim 1 further comprising moving the file to an error directory if the file fails the encryption process.

12. The method of claim 1 further comprising recording information about the file in an error log if the file fails the encryption process.

13. The method of claim 1 further comprising:
retrieving the file from the outgoing box;
transmitting the file to the destination; and
verifying receipt of the file at the destination.

14. The method of claim 1 further comprising receiving the file in the destination based transmit folder wherein a user selects a file destination and places the file in the destination based transmit folder corresponding to the file destination.

15. The method of claim 1 wherein retrieving the file from the destination based transmit folder comprises automatically checking the destination based transmit folder for new files after a predetermined time interval and retrieving new files found in the destination based transmit folder.

16. The method of claim 1 further comprising transmitting the encrypted file.

17. The method of claim 1 further comprising transmitting the encrypted file over an insecure channel.

18. The method of claim 1 wherein the encryption process comprises a public key for encoding the file.

19. The method of claim 1 further comprising generating a file notifying a recipient at the destination that the file is being transmitted.

20. The method of claim 1 further comprising performing a scan for encryption key software to find the encryption process.

21. The method of claim 1 further comprising transmitting a list of files from the destination based transmit folder to the outgoing folder to reconcile files being transferred from the transmit folder to the outgoing folder.

22. The method of claim 1 further comprising compressing the data.

23. A system for transmitting data comprising:
means for retrieving a file from a destination based transmit folder;
means for encrypting the file with an encryption process associated with the destination based transmit folder; and
means for transmitting the file to an outgoing folder for transmission to the destination.

24. The system of claim 23 further comprising means for retrieving the encryption process associated with the destination based transmit folder from an encryption database.

25. The method of claim 23 further comprising means for verifying that the file has been encrypted.

26. The system of claim 23 further comprising:
means for retrieving the file from the outgoing box;
means for transmitting the file to the destination; and
means for verifying receipt of the file at the destination.

27. A method for receiving data comprising:
retrieving a file from a destination based received folder;
decrypting the file with a decryption process associated with the destination based received folder; and
transmitting the file to an outgoing folder for access at the destination.

28. The method of claim 27 further comprising retrieving the decryption process associated with the destination based received folder from a decryption database.

29. The method of claim 27 further comprising verifying that the file has been decrypted.

30. The method of claim 29 wherein verifying that the file has been decrypted comprises transferring the file to a temporary folder and checking if all files in the temporary folder have been decrypted.

31. The method of claim 29 further comprising moving the file to an error directory if the file fails the verification process.

32. The method of claim 29 further comprising recording information about the file in an error log if the file fails the verification process.

33. The method of claim 32 further comprising transmitting a destination based portion of the error log to the destination.

34. The method of claim 29 wherein transmitting the file to the outgoing folder comprises transmitting the verified file to the outgoing folder.

35. The method of claim 29 further comprising transmitting notification of decryption failure of the file to the destination if the file fails verification.

36. The method of claim 27 further comprising transmitting notification of decryption failure of the file to the destination if the file fails decryption.

37. The method of claim 27 further comprising moving the file to an error directory if the file fails the decryption process.

38. The method of claim 27 further comprising recording information about the file in an error log if the file fails the decryption process.

39. The method of claim 27 wherein retrieving the file from the destination based received folder comprises automatically checking the destination based received folder for new files after a predetermined time interval and retrieving new files found in the destination based received folder.

40. The method of claim 27 further comprising receiving the file in a file received inbox and placing the file in the destination based received folder.

41. The method of claim 40 wherein receiving the file comprises receiving the file over an insecure channel.

42. The method of claim 41 wherein placing the file in the appropriate destination based received folder comprises determining the destination of the file.

43. The method of claim 27 wherein the decryption process comprises a private key for decoding the file.

44. The method of claim 27 further comprising performing a scan for decryption key software to find the decryption process.

45. The method of claim 27 further comprising transmitting a list of files from the destination based received folder to the outgoing folder to reconcile files being transferred from the received folder to the outgoing folder.

46. The method of claim 27 further comprising decompressing the data.

47. A system for receiving data comprising:
means for retrieving a file from a destination based received folder;
means for decrypting the file with a decryption process associated with the destination based received folder; and
means for transmitting the file to an outgoing folder for access at the destination.

48. The system of claim 47 further comprising means for retrieving the decryption process associated with the destination based received folder from an encryption database.

49. The method of claim 47 further comprising means for verifying that the file has been decrypted.

50. The method of claim 47 further comprising means for receiving the file in a file received inbox and placing the file in the destination based received folder.

51. A method for transmitting data comprising:
automatically retrieving data from a destination based transmit folder;
automatically retrieving an encryption process associated with the destination based transmit folder;
encrypting the data with the encryption process; and
transmitting the data to an outgoing folder for transmission to the destination.

52. The method of claim 51 wherein the encryption process comprises an encryption key.

53. The method of claim 51 further comprising transferring the data to a temporary folder to verify that the data has been encrypted.

54. The method of claim 51 further comprising performing error processing on the data if the data fails verification.

55. The method of claim 51 further comprising performing error processing on the data if the data fails encryption.

56. A system for transmitting data comprising:
means for automatically retrieving data from a destination based transmit folder;
means for automatically retrieving an encryption process associated with the destination based transmit folder;
means for encrypting the data with the encryption process; and
means for transmitting the data to an outgoing folder for transmission to the destination.

57. The system of claim 56 wherein the encryption process comprises an encryption key.

58. The system of claim 56 further means for comprising transferring the data to a temporary folder to verify that the data has been encrypted.

59. The system of claim 58 further comprising means for performing error processing on the data if the data fails verification.

60. The method of claim 58 further comprising means for performing error processing on the data if the data fails encryption.

61. A method for receiving data comprising:
automatically placing received data in a destination based received folder;
automatically retrieving data from the destination based received folder;
automatically retrieving a decryption process associated with the destination based received folder;
decrypting the data with the decryption process; and
transmitting the data to an outgoing folder for access at the destination.

62. The method of claim 61 wherein the encryption process comprises an encryption key.

63. The method of claim 61 further comprising transferring the data to a temporary folder to verify that the data has been decrypted.

64. The method of claim 63 further comprising performing error processing on the data if the data fails verification.

65. The method of claim 61 further comprising performing error processing on the data if the data fails decryption.

66. A system for receiving data comprising:
means for automatically placing received data in a destination based received folder;
means for automatically retrieving data from the destination based received folder;
means for automatically retrieving a decryption process associated with the destination based received folder;
means for decrypting the data with the decryption process; and
means for transmitting the data to an outgoing folder for access at the destination.

67. The system of claim 66 wherein the encryption process comprises an encryption key.

68. The system of claim 66 further comprising means for transferring the data to a temporary folder to verify that the data has been decrypted.

69. The system of claim 68 further comprising means for performing error processing on the data if the data fails verification.

70. The system of claim 66 further comprising means for performing error processing on the data if the data fails decryption.

71. An automatic encryption system for data to be transmitted comprising:
an encryption module receiving data in a destination based transmit folder and automatically encrypting the data with an encryption method associated with the destination based transmit folder;
an encryption database storing encryption methods, each encryption method associated with at least one destination based transmit folder;
an error module performing error processing on data failing encryption.

72. The system of claim 71 further comprising a file compression module compressing the data to be transmitted.

73. The system of claim 71 wherein the encryption module comprises a verification module verifying encryption of the data.

74. An automatic decryption system for received data comprising:
an decryption module receiving data in a destination based received folder and automatically decrypting the data with a decryption method associated with the destination based received folder;
an decryption database storing decryption methods, each decryption method associated with at least one destination based received folder;
an error module performing error processing on data failing decryption.

75. The system of claim 74 further comprising a file decompression module decompressing the received data.

76. The system of claim 74 wherein the decryption module comprises a verification module verifying decryption of the data.
